(19) United States
(12) Patent Application Publication
(10) Pub. No.: US 2004/0064952 A1
(43) Pub. Date: Apr. 8, 2004

(54) Multi-use kitchen tool

(76) Inventor: Andrew J. Armienta, Patterson, CA (US)

Correspondence Address: Henneman & Saunders, 714 W. Michigan Ave., Three Rivers, MI, 49093, US

(21) Appl. No.: 10/610,516

(22) Filed: Jun. 30, 2003

Related U.S. Application Data
(63) Continuation-in-part of application No. 29/170,720, filed on Nov. 12, 2002, now Pat. No. D479959.
Application No. 29/170,720 is a division of application No. 09/533,575, filed on Mar. 23, 2000, now Pat. No. 6,490,796.
(60) Provisional application No. 60/134,169, filed on May 13, 1999.

(51) Int. Cl. A47J 43/28

(52) U.S. Cl. 30/142; 30/149; 30/325; 294/7

(57) ABSTRACT

A cooking utensil includes a body with a depressed portion, a handle extending from the body in a first direction, and a blade extending from the body in a second direction not parallel to the first direction. The body has a curved leading edge that is continuous with a lateral edge of the blade. The upper boundaries of the depressed portion of the body form a plane that makes a non-zero angle with the plane of the blade. A leading edge of the blade is sharpened to facilitate use of the utensil as a cleaver. In various embodiments, the orientation of the handle with respect to the body is modified in a number of ways to prevent interference with a side wall of a cooking container.

### RELATED APPLICATIONS

This application is a continuation-in-part of co-pending U.S. patent application Serial No. 29/170,720, entitled “Multi-Use Kitchen Tool,” filed Nov. 12, 2002, by the same inventor, which is a division of U.S. patent application Ser. No. 09/533,575, now U.S. Pat. No. 6,490,796, entitled “Multi-Use Kitchen Tool,” filed Mar. 23, 2000, by the same inventor, which is a continuation-in-part of U.S. Provisional Application Serial No. 60/134,169, filed by the same inventor on May 13, 1999. All prior applications are incorporated herein by reference in their entirety.

### BACKGROUND OF THE INVENTION

1. Field of the Invention

This invention relates generally to culinary implements, and more particularly to a utensil that performs multiple culinary tasks.

In any kitchen, whether restaurant or private, there are numerous tools designed to aid in the preparation of food. Common kitchen tools include spoons, spatulas, cleavers, and the like. The spoon has a function of scooping and retaining various foods, including gravies and other liquids. It is common for spoon to have drainage slots or holes for allowing the passage of a fluid (e.g., broth), while retaining larger pieces of solid food. A spatula is useful for turning, lifting, and transferring foods. A spatula typically has a flat blade with a leading edge that allows the blade to slip between foods and a cooking surface (e.g., the bottom of a pan or a griddle). The spatula, like the spoon, commonly contains drainage openings designed to allow liquids such as grease or oil to pass through them. A cleaver is a sharp, tall bladed knife typically used for chopping or slicing foods. The cleaver aids in the processing of foods that require a more specialized utensil than a standard knife, such as foods already being prepared in a deep pan, or foods that require more force to be chopped (e.g., hard vegetables or meats).

While each of the above described utensils is particularly useful for its intended purpose, using multiple utensils simultaneously results in many inconveniences. One problem associated with using multiple utensils is their use of kitchen space. Each utensil requires its own counter-space, to be rested on when not in use by the chef, and its own cupboard space to be stored in. Resting each utensil on the counter when cooking consumes the chef's valuable work area, and increases the mess resulting from excess food residue on the utensils, which must be cleaned up. Furthermore, purchasing multiple utensils is costly, because well-made kitchen utensils are expensive. In addition, switching between various utensils while preparing foods consumes the chef's valuable time. This loss of time, even if small, can cause over-cooking of certain foods and the resultant waste of food that is then not suitable for serving. All of these problems contribute to chef frustration in their attempt to timely prepare high quality food.

The use of known individual utensils also inherently limits the functionality of each particular utensil to its intended purpose, and there are some combined functions for which no utensil exists. For example, when cooking an omelet in a frying pan with a curved side, there is no known utensil for lifting and turning the omelet (e.g., spatula function) and detaching the omelet from the curved side wall of the pan. The straight leading edged of the spatula does not conform to the curved wall of the pan.

Another problem typically occurs when using a spatula in cooking containers having curved walls. Trying to lift or turn foods near the wall of the container is often difficult because the wall of the container can interfere with the spatula handle.

What is needed is a kitchen utensil that combines the specialized functions of various culinary implements in a single utensil, in order to minimize the inconveniences and expense associated with using separate utensils. What is also needed is a utensil that combines the functionality of known, individual utensils into a single utensil.

### SUMMARY

The present invention overcomes the problems associated with the prior art by combining the functions of multiple culinary implements into a single, novel kitchen utensil, thus reducing the cost and inconvenience of using multiple utensils.

One particular embodiment of the present invention includes a body having a depressed portion (e.g., a spoon) formed therein, a handle extending from the body in a first direction, and a blade (e.g., a spatula) extending from the body in a second direction. Optionally, the depressed portion of the body and/or the blade defines one or more apertures to facilitate fluid flow therethrough. The handle and the blade extend in directions that are not parallel to one another. In a more particular embodiment, the handle and the blade are perpendicular to one another. Additionally, the plane of the blade forms a nonzero angle with a plane defined by the upper boundary of the depressed portion of the body (e.g., spoon lip).

The body includes a curved leading edge designed to uniformly contact a curved wall of a cooking container. In a more particular embodiment the curved leading edge of the body is detachable to facilitate the use of leading edges of varying contours.

The flat blade extending from the body includes a flat lateral edge adapted to contact the bottom surface of the cooking container. Optionally, the lateral edge of the blade is continuous with the curved leading edge of the body. In a particular embodiment the blade includes a sharpened leading edge to facilitate the chopping and slicing of foods. In addition, the sharpened leading edge of the blade facilitates the lifting of food from the bottom of a cooking container, as does the lateral edge of the blade, such that the blade can function as a spatula in either the forward or lateral direction.

Optionally, the handle of the cooking utensil can be modified to prevent interference with a side wall of a cooking container. In a particular embodiment the handle includes a first section extending from the body of the utensil in a first direction and a second section extending from the first section of the handle in a second direction. The first section of the handle elevates the second section above the plane defined by the upper boundary of the body. Generally, the second section of the handle is elevated by at least an inch. In another particular embodiment, the first section of the handle can be attached to a junction between the body and the blade of the cooking utensil. In still another particular embodiment, the blade of the cooking utensil lies in one plane, and the handle is angled away from the plane of the blade such that the handle does not interfere with a side wall of the cooking container when the blade is laid flat on the cooking surface. One or more of the particular embodiments of the handle can be combined as required for particular applications.

### BRIEF DESCRIPTION OF THE DRAWINGS

The present invention is described with reference to the following drawings, wherein like reference numbers denote substantially similar elements:

FIG. 1 shows a perspective view of a cooking utensil in accordance with the present invention;

FIG. 2 shows a top view of the cooking utensil shown in FIG. 1;

FIG. 3 shows a leading edge view of the cooking utensil shown in FIG. 1;

FIG. 4 shows a perspective view of another cooking utensil in accordance with the present invention;

FIG. 5A shows a leading edge view of still another cooking utensil in accordance with the present invention;

FIG. 5B shows a top view of the cooking utensil of FIG. 5A; and

FIG. 6 is a perspective view of yet another cooking utensil in accordance with the present invention.

### DETAILED DESCRIPTION

The present invention overcomes the problems of the prior art by providing a single cooking utensil that performs multiple cooking functions. In the following description, numerous specific details are set forth (e.g. construction materials, fluid apertures, etc.) in order to provide a thorough understanding of the invention. Those familiar with culinary implements will recognize, however, that the invention may be practiced apart from these specific details.

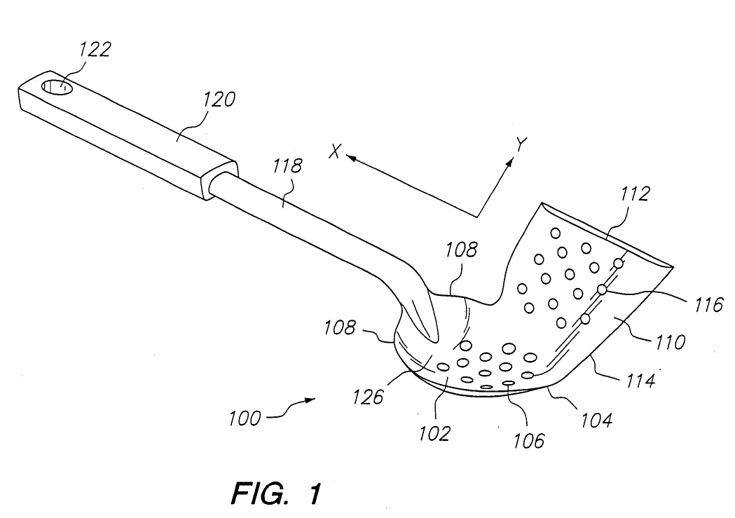

FIG. 1 is a perspective view of cooking utensil 100, according to one embodiment of the present invention. Cooking utensil 100 includes a metallic body 102 (a spoon portion), a metallic handle 118 extending from body 102 in a first direction (X), and a flat, metallic blade 110 (a spatula portion) extending from body 102 in a second direction (Y). In this particular embodiment, handle 118 and blade 110 are disposed roughly perpendicular to one another. Body 102 includes a depressed portion 126, a plurality of apertures 106, an upper boundary (spoon lip) 108, and a curved leading edge 104. Blade 110 includes a leading edge 112, a lateral edge 114, and a plurality of apertures 116. Handle 118 includes an insulated portion 120, and a hanging aperture 122.

Body 102 collects and retains food in depressed portion 126. Curved leading edge 104 is fashioned to facilitate uniform contact with a curved side-wall of a cooking container (e.g. the curved side of a frying pan), and functions to thoroughly detach any food adhering to the curved side-wall. In addition, leading edge 104 provides a larger contact area between body 102 and the cooking container than does a conventional spoon. This large contact area makes it easier to scoop slippery and/or diced foods from the cooking container. Optional apertures 106 allow fluids (e.g., grease, oil, broth, etc.) to flow out of depressed portion 126.

Blade 110 is attached to body 102 along upper boundary 108 of depressed portion 126. Blade 110 extends away from body 102 in direction (Y), and lies in a plane that forms a non-zero angle with the plane defined by upper boundary 108 of body 102. This angular relationship between blade 110 and body 102 allows blade 110 to lie flat on a cooking surface when body 102 is held at an angle to the cooking surface, without interference by depressed portion 126 of body 102. Leading edge 112 and lateral edge 114 of blade 110 permit the scooping of food (typically solid food) onto blade 110 and, optionally, into body 102. Typically, spatula type utensils scoop food using a forward motion, however, by utilizing both lateral edge 114 and leading edge 112 of cooking utensil 100 scooping may be accomplished by both lateral and/or forward motion. In this particular embodiment of cooking utensil 100, lateral edge 114 of blade 110 is continuous with leading edge 104 of body 102. This allows for simultaneous food collection from a curved side-wall and the bottom of a cooking container. Leading edge 112 is also sharpened to facilitate the slicing or chopping of food. Because blade 110 extends in a direction (Y) roughly perpendicular to handle 118, utensil 100 can be conveniently used as a cleaver. Blade 110 optionally includes a plurality of apertures 116 for allowing fluid to flow through blade 110.

It should be noted that blade 110 functions primarily as a turning blade/spatula for lifting and turning such food items as pancakes, hamburgers or the like. Turning blades/spatulas are well known to those skilled in the art and are readily distinguishable from blades that are intended for scraping the inside of containers such as jars and bowls, at least in part based on the length of the blade. The size of the turning blade will vary depending on the size of the food, however, in any case the blade must be of sufficient length to facilitate the lifting of the food item being turned. For example, if blade 110 is designed to turn pancakes it would be substantially larger than if it is designed to turn smaller foods such as sausage patties. In any case, such utensils used for lifting and turning food are commonly known in the art as “turners” or “turning blades.” Further, while turners come in a great variety of shapes and sizes, one skilled in the art is readily able to distinguish a “turner” from ajar scraper or the like.

Cooking utensil 100 may be produced using a variety of materials including, but not limited to, metal, nylon, plastic, and wood. Each material offers it own particular advantages and disadvantages, and so material selection will depend on the intended use of utensil 100. For example, fabricating cooking utensil 100 from metal allows leading edge 112 of blade 110 to be sharpened and to retain a sharp edge. In addition, metal provides added strength and durability that may be required in some applications to use cooking utensil 100 as a cleaver. On the other hand, metal is more expensive, and must include insulated portion 120 or similar protection for the user against burns caused by heat transfer from the cooking container to cooking utensil 100. As another example, if utensil 100 is intended for use with cookware having a non-stick surface or other surface susceptible to damage from scratching, it may desirable to manufacture utensil 100 from nylon or plastic. Additionally, plastic utensils are generally less expensive to manufacture than their metal counterparts. On the other hand, plastics are not generally as strong as metals, and some plastics might not, therefore, be suitable in applications such as cleaving meat. Plastic would, however, be suitable for cleaving soft foods such as scrambled eggs Manufacturing different portions of utensil 100 of different material types is also possible. For example, both body 102 and handle 118 may be fashioned from nylon, while blade 110 may be fashioned from metal, with leading edge 112 of blade 110 is sharpened as described above. This alternate embodiment would be a lightweight utensil capable of chopping and/or slicing tougher foods, as well as remaining cool when used with high temperatures.

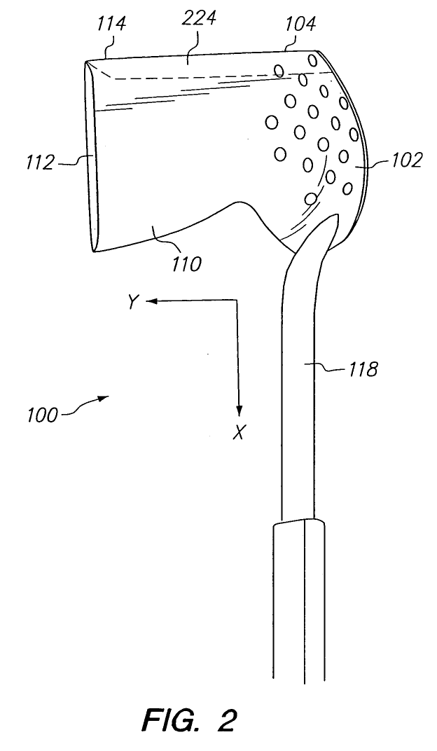

FIG. 2 displays a top view (blade 110 lying in the plane of the page) of cooking utensil 100. As described above, blade 110 extends from body 102 in a direction roughly perpendicular to the extending direction of handle 118. The view of FIG. 2 illustrates how utensil 100 can function as a cleaver. Utensil 100 can be used to chop foods with leading edge 112 by swinging utensil 100 in direction (Y) by handle 118. Utensil 100 can be used to slice foods with leading edge 112 by drawing utensil 100 back and forth along direction (X).

In an alternate embodiment, leading edge 104 of body 102 and/or lateral edge 114 of blade 10 are embodied in a detachable component 224 (shown representationally by the dotted line in FIG. 2). For example, component 224 can be formed from a heat resistant plastic and be adapted to slip over leading edge 104 and lateral edge 114. This particular embodiment has the advantage that various detachable components could be used with a single utensil 100 to facilitate uniform contact with cooking containers having various sizes and/or unique curvatures. Furthermore, detachable component 224 provides protection against abrasions caused by a metallic body 102, thus achieving the above described advantages of a metallic utensil (e.g., strength, etc.) in addition to the advantages of plastic (e.g., won't damage cookware).

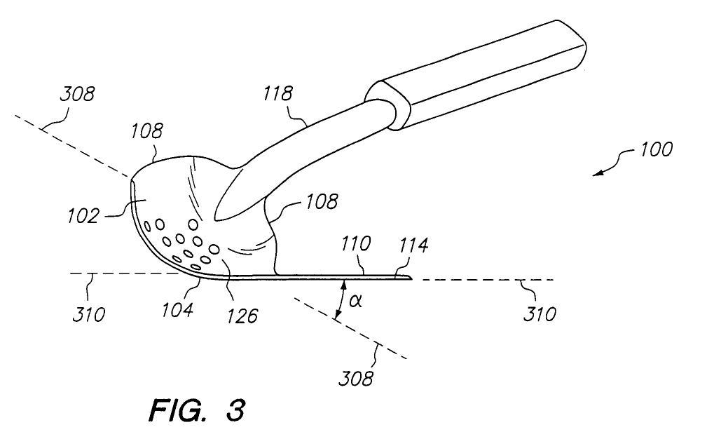

FIG. 3 is an edge view of continuous leading edge 104 of body 102 and lateral edge 114 of blade 110. The curvature of leading edge 104 facilitates uniform detachment of foods adhering to the curved side-wall of a cooking container (e.g. a frying pan) while lateral edge 114 slips under and detaches foods adhering to the bottom of the cooking container.

The angular relationship between body 102 and blade 110 insures that body 102 will not interfere with blade 110 lying flat on the bottom of a cooking surface. An upper plane 308 is defined by upper boundary 108 of depressed portion 126. Blade 11 lies in a second plane 310, which intersects upper plane 308 at a non-zero angle, alpha (α). Ideally, lateral edge 114 is tangent to leading edge 104 at angle alpha (α), but those skilled in the art will understand that, in some cases, it may be desirable to increase or decrease this angle to accommodate particular contours of cooking surfaces. When angle alpha is decreased beyond the point where lateral edged 114 is tangent to leading edge 104, at least a portion of depressed portion 126 is disposed below blade plane 310, and therefore interferes with blade 110 lying flat on a cooking surface. If alpha is decreased to 0 degrees, then the entire depressed portion 126 of body 102 would lie beneath plane 310.

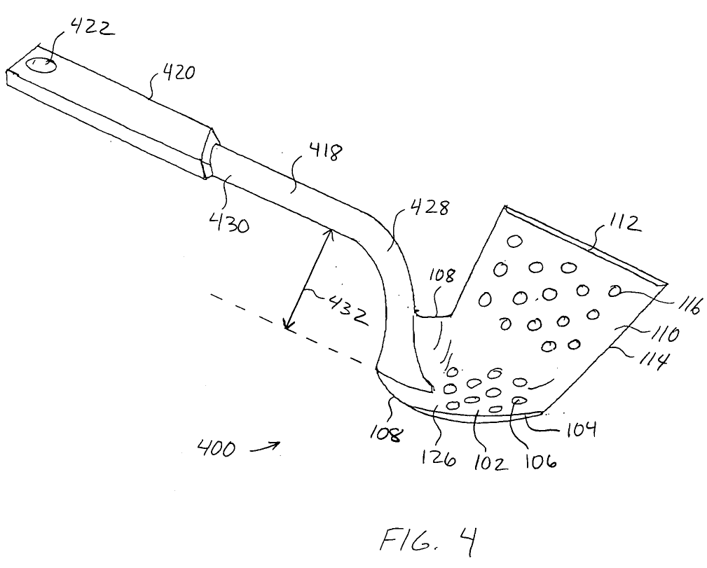

FIG. 4 shows a perspective view of a cooking utensil 400 according to an alternate embodiment of the present invention. Utensil 400 is similar to utensil 100 of FIG. 1, except utensil 400 includes an alternate handle 418. Handle 418 includes an insulated portion 420 and a hanging aperture 422 that function similarly to insulated portion 120 and hanging aperture 122, respectively of FIG. 1.

Handle 418 is further defined by a first section 428 and a second section 430. First section 428 extends from body 102 (a spoon portion) in a first direction which, in the present embodiment, is generally upward from body 102. Second section 430 of handle 418 extends from first section 428 in a second direction which is generally away from first section 428 and body 102. First section 428 is inclined and has a rise 432, taken with respect to the plane defined by upper boundary 108 of body 102, which elevates second section 430 a distance sufficient to prevent interference between a side wall of a cooking container (e.g., the curved wall of a frying pan) and handle 418 when blade 110 (a spatula portion) is placed flat on the cooking surface of the cooking container. Note that second section 430 is generally parallel to the plane defined by upper boundary 108 of body 102, but this is not necessarily a requirement of the invention.

Rise 432 can be increased or decreased to fit different size cooking containers. For example, in the case of a utensil sized for a small frying pan, rise 432 would be at least an inch in length. Accordingly, rise 432 can be increased from an inch to ensure handle 418 does not interfere with the side walls of larger cooking containers.

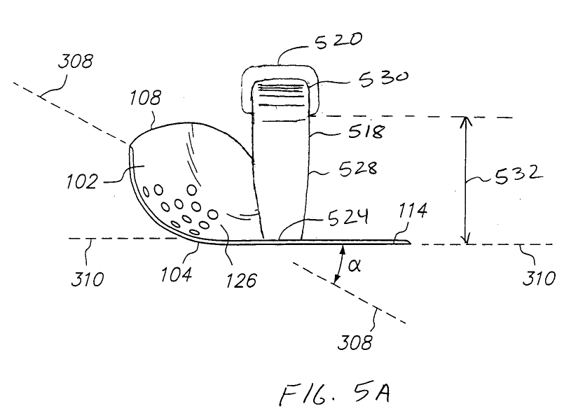

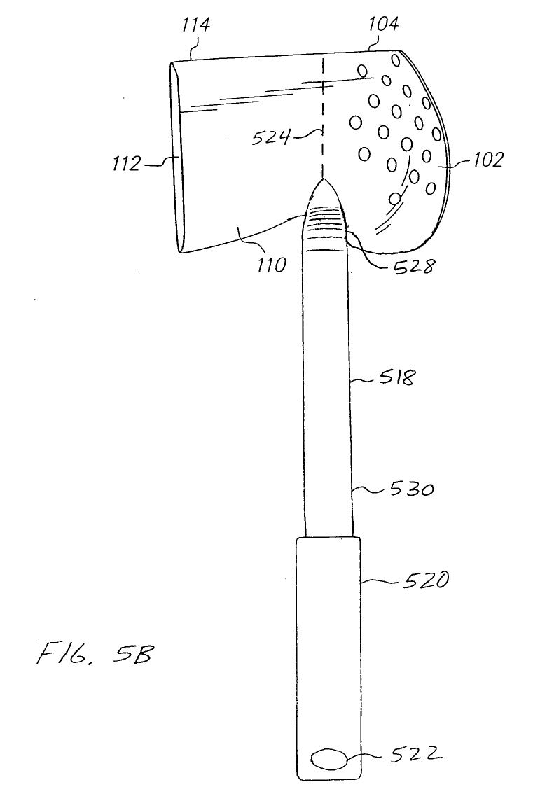

FIGS. 5A and 5B show a cooking utensil 500, which illustrates yet another embodiment of the present invention. Cooking utensil 500 is also modified to prevent interference between itself and a side wall of a cooking container. Utensil 500 is similar to utensil 100 of FIG. 1, but includes an alternate point of attachment for handle 518. Handle 518 includes an insulated portion 520 and a hanging aperture 522 that function similarly to insulated portion 120 and hanging aperture 122, respectively, of FIG. 1.

Handle 518 is coupled to body 102 and blade 110 near a junction 524 between body 102 and blade 110, and includes a first section 528 and a second section 530. First section 528 extends from junction 524 in a first direction which, in the present embodiment, is generally upward from the plane defined by blade 110. Second section 530 of handle 518 extends from first section 528 in a second direction, which is generally horizontal and away from first section 528 and body 102. First section 528 has a rise 532 which elevates second section 530 a distance sufficient to prevent interference between a side wall of a cooking container and handle 518 when blade 110 is placed flat on the cooking surface of the cooking container. Rise 532 can be increased or decreased to fit different size cooking containers as required, but generally would be at least an inch in length.

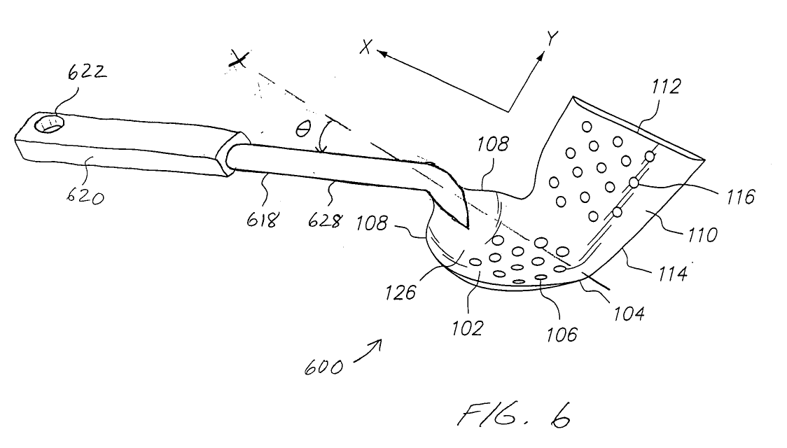

FIG. 6 shows yet another embodiment of a cooking utensil 600 in accordance with the present invention. Utensil 600 is similar to utensil 100 of FIG. 1 except that utensil 600 includes a handle 618 which is different from handle 118. Handle 618 is composed of a first section 628, and an insulated portion 620 having a hanging aperture 622 formed therein. Similar to the embodiments shown in FIGS. 4-5B, the primary advantage of orienting handle 618 as shown is to prevent interference between handle 618 and a side wall of a cooking container such as a frying pan.

As shown in the present embodiment, blade 110 extends from body 102 and lies in an X-Y plane, which is roughly parallel to upper boundary 108 of body 102. Handle 618 extends from body 102 generally in the X direction, but is rotated away from the X-Y plane through an offset angle theta (θ). Note that the X-axis is roughly parallel to a longitudinal bisector of body 102. Rotating handle 618 by an amount θ ensures that handle 618 will not interfere with a side wall of a cooking container when edge 112 of blade 110 is angled against the bottom surface of the cooking container.

The angle θ can be adjusted as required for use with different cooking containers. For example, in order for handle 618 not to interfere with the wall of a large frying pan, the angle θ could be as large as 60 degrees. However, for a shallow walled skillet, an angle of only 30 degrees or less might be sufficient.

Additionally, it should be noted that several embodiments of the present invention can be combined. For example, handle 418 shown in FIG. 4 could be combined with handle 618 yielding a handle having first portion 428, second portion 430, and rise 432 as well as an offset angle θ to yield even more clearance over a wall of a cooking container.

The detailed description of particular embodiments of the present invention is now complete. Many of the described features may be substituted, altered, or omitted without departing from the scope of the invention. Accordingly, no single feature is considered to be an essential element of the present invention, and the scope of the invention is only limited by the following claims which may be amended during the prosecution of the application.

I claim:

1. A cooking utensil comprising:
a body having a depressed portion formed therein;
a handle extending from said body in a first direction; and
a turner blade extending from said body in a second direction not parallel to said first direction.

2. A cooking utensil according to claim 1, wherein the length of said turner blade along said second direction is at least as long as said depressed portion's width along said second direction.

3. A cooking utensil according to claim 1, wherein an upper boundary of said depressed portion of said body lies in a first plane that forms a non-zero angle with said blade.

4. A cooking utensil according to claim 1, wherein said handle comprises:
a first section extending generally upward from said body; and
a second section extending from said first section at an angle.

5. A cooking utensil according to claim 4, wherein said first section elevates said second section with respect to said an upper boundary of said body, thereby increasing the height of said handle with respect to a cooking surface when said utensil is used.

6. A cooking utensil according to claim 5, wherein said first section elevates said second section of said handle above said upper boundary of said body by at least an inch.

7. A cooking utensil according to claim 1, wherein said handle is attached near the junction of said body and said blade.

8. A cooking utensil according to claim 7, wherein:
said handle comprises a first section extending from said junction in a first direction, and a second section extending from said first section in a second direction; and
said first section elevates said second section with respect to said blade.

9. A cooking utensil according to claim 1, wherein:
said turner blade lies in a plane;
said handle forms a non-zero angle with respect to said plane of said turner blade.

10. A cooking utensil according to claim 9, wherein said handle forms a non-zero angle with respect to a longitudinal bisector of said body.

11. A cooking utensil comprising:
a spoon having a handle; and
a turner spatula extending from a lateral edge of said spoon in a first direction not parallel to said handle.

12. A cooking utensil according to claim 11, wherein said turner spatula is at least as long as said spoon's width along said first direction.

13. A cooking utensil according to claim 11, wherein a lip of said spoon lies in a first plane that forms a non-zero angle with said spatula.

14. A cooking utensil according to claim 10, wherein said handle comprises:
a first section extending generally upward from said spoon; and
a second section extending from said first section at an angle.

15. A cooking utensil according to claim 14, wherein said first section elevates said second section with respect to said spoon, thereby increasing the height of said handle with respect to a cooking surface when said utensil is used.

16. A cooking utensil according to claim 15, wherein said first section elevates said second section of said handle above said spoon by at least an inch.

17. A cooking utensil according to claim 11, wherein said handle is attached near the junction of said spoon and said turner spatula.

18. A cooking utensil according to claim 17, wherein:
said handle comprises a first section extending from said junction in a first direction, and a second section extending from said first section in a second direction; and
said first section elevates said second section with respect to said turner spatula.

19. A cooking utensil according to claim 10, wherein:
said turner spatula lies in a plane;
said handle forms a non-zero angle with respect to said plane of said turner spatula.

20. A cooking utensil according to claim 19, wherein said handle forms a non-zero angle with respect to a longitudinal bisector of said spoon.
